(19) United States
(12) Patent Application Publication
(10) Pub. No.: US 2009/0178888 A1
(43) Pub. Date: Jul. 16, 2009

(54) Gondola With On-board Safety and Drive Mechanism

(76) Inventors: Manuel Machado, Paris (FR); Jacques Lepine, Paris (FR)

Correspondence Address: Manuel Machado, 43 rue de Plaisance, La Garenne Colombes, 92250, FR

(21) Appl. No.: 12/087,164

(22) PCT Filed: Nov. 29, 2006
(86) PCT No.: PCT/FR2006/002614

§ 371 Date: Nov. 13, 2008

(30) Foreign Application Priority Data
Dec. 2, 2005 (FR) 0512246

(51) Int. Cl. B66B 9/02

(52) U.S. Cl. 187/250

(57) ABSTRACT

The present invention relates to a lifting device secured in height along a wall comprising a gondola, characterised in that the safety and drive means are on-board on the gondola and cause the gondola to slide along the two rails by means of a pair of secure jaws, the actions of which are coordinated so as to advance along each rail with an alternating clearance.

The present invention relates to a gondola with an on-board safety and drive mechanism. The invention applies more particularly to a support guide constituted by two rails. The support guide is positioned in a fixed or temporary manner along facades, posts or ladders. The invention finds numerous applications for work or accesses in high places, public lighting, cranes, cleaning of facades, access to the roofs of buildings, ascending up telecommunications posts, cable cars, access ladders. The invention has another outlet in the on-board motorisation of lift cages. The invention offers a great advance both in terms of safety and ease of use and in cost-savings.

Various devices are known for gondolas or lifts. For the purpose of safety on gondolas of the prior art, it is necessary to arrange a cable which connects roughly the upper point to the lower point of the path of the gondola. The cable is provided with a device for setting in motion, which is on-board on the gondola solidly connected at a specific point of the cable. The safety feature consists either in a duplication of the cable or in an improved braking mechanism positioned around the cable. These devices of the prior art have, in particular, the first main drawback of having to provide high anchoring points for the cables, the second drawback of subjecting the safety to the durability of the cable, the third drawback of making available an extremely complex and sometimes defective braking system and finally the fourth drawback of being costly. The safety features are only engaged in the event of a malfunction of the system. The safety is not permanent, but only comes into play in the event of a problem.

A main aim of the invention is to propose a lifting device which is fully secured and has on-board motorisation and safety.

An aim of the invention is to propose a device which uses a ground-level access prohibition, as proposed by the use of a support guide which is a profile comprising two advancing rails.

An aim of the invention is to propose an advancing device, the advance of which along the support guides is at a constant or almost constant speed during the advance along the support guide.

An aim of the invention is to propose a gondola which is easy to use, has a reasonable cost and can be applied to any type of vertical or essentially vertical partition wall, a wall, existing ladders, a crane or wind-power-engine cage.

An aim of the invention is to provide functioning both during the ascent and the descent, and without functional modification apart from the operation of a specific button.

An aim of the invention is to propose a gondola safety feature which is continuous in time and which is present even before the appearance of possible problems. The presence of a problem simply leads at worst to a locking of the equipment and under no circumstances to a risk of falling.

In a main aspect, the invention comprises a motorised operating mechanism which operates a safety and drive mechanism comprising two symmetrically identical suspension systems positioned on each of the advancing rails.

In an aspect of the invention, the movements of the two suspension systems positioned on each of the rails are linked and perfectly co-ordinated in such a way as to cause one of the systems to advance when the other remains secure.

The appended figures show a particular embodiment of the invention, in which:

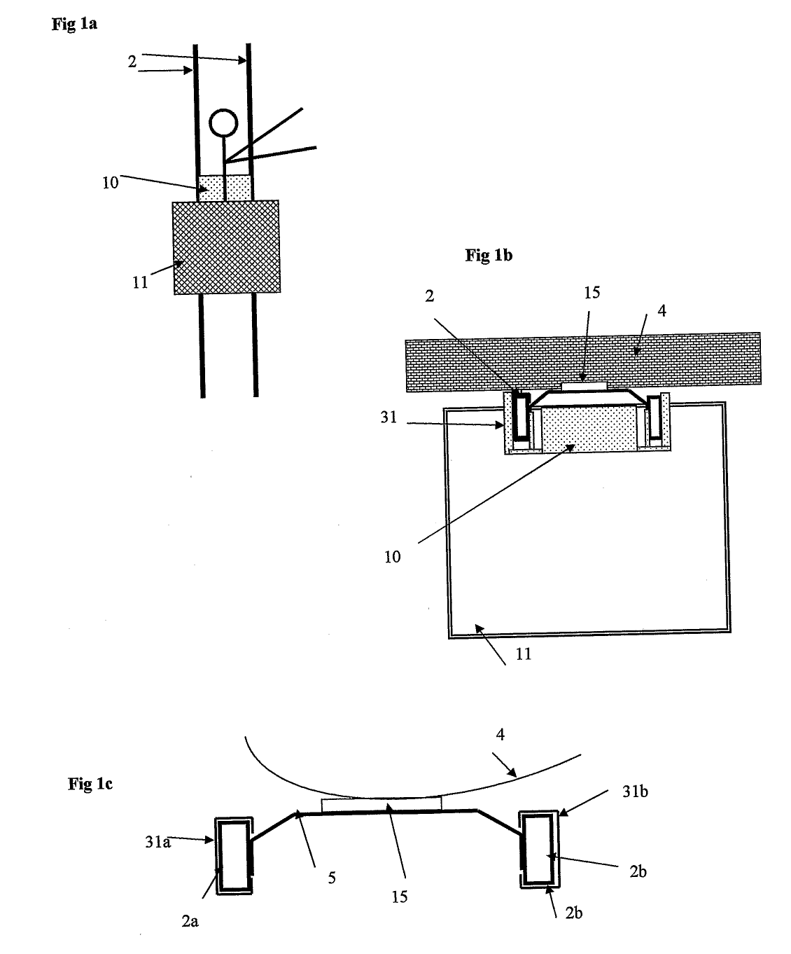

FIGS. 1a and 1b shows a front view and plan view of the gondola on the support guide according to the invention

FIG. 1c shows a plan view of the gondola support guide according to the invention

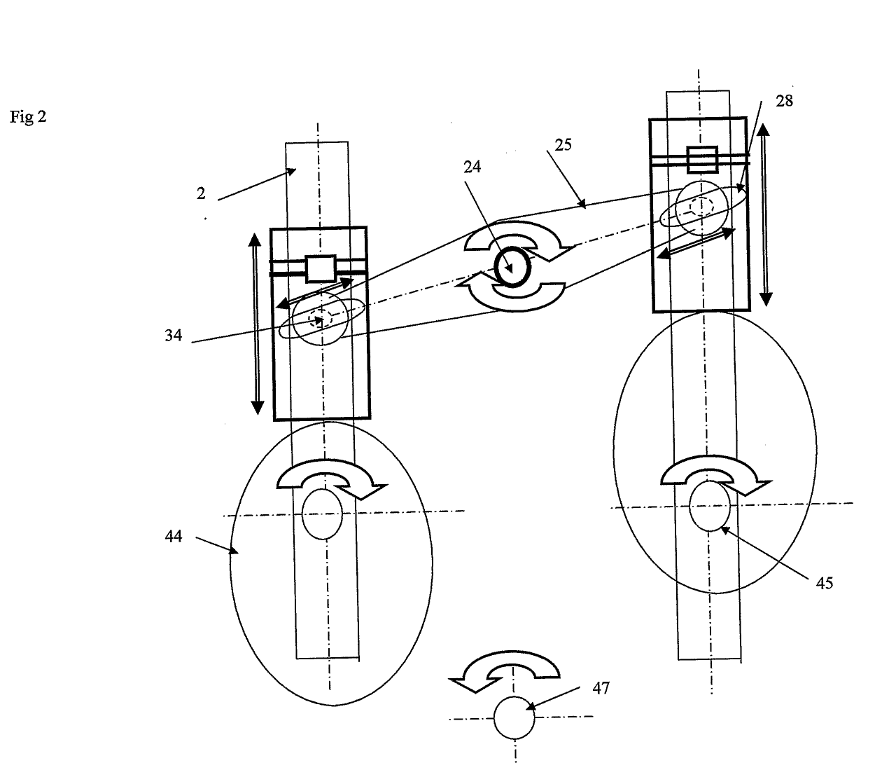

FIG. 2 shows a general front view of the safety and drive mechanism on the support guide

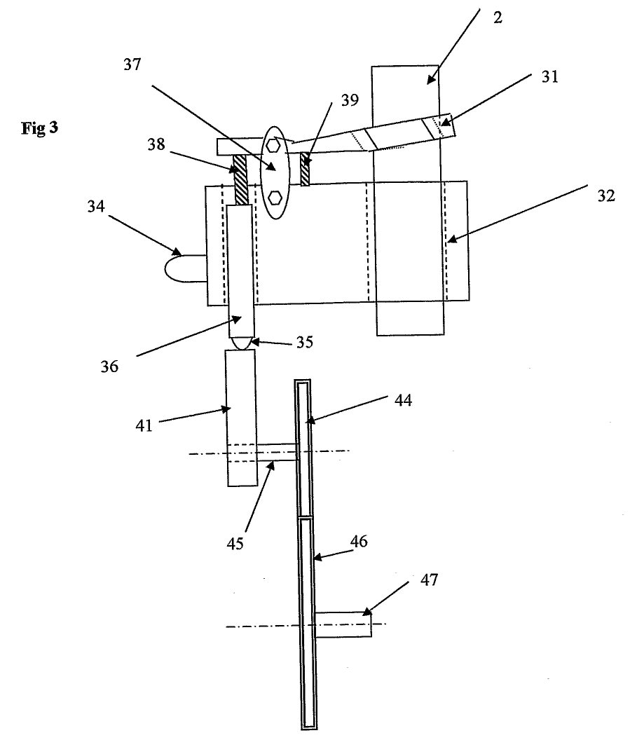

FIG. 3 shows a side view of the safety and drive mechanism

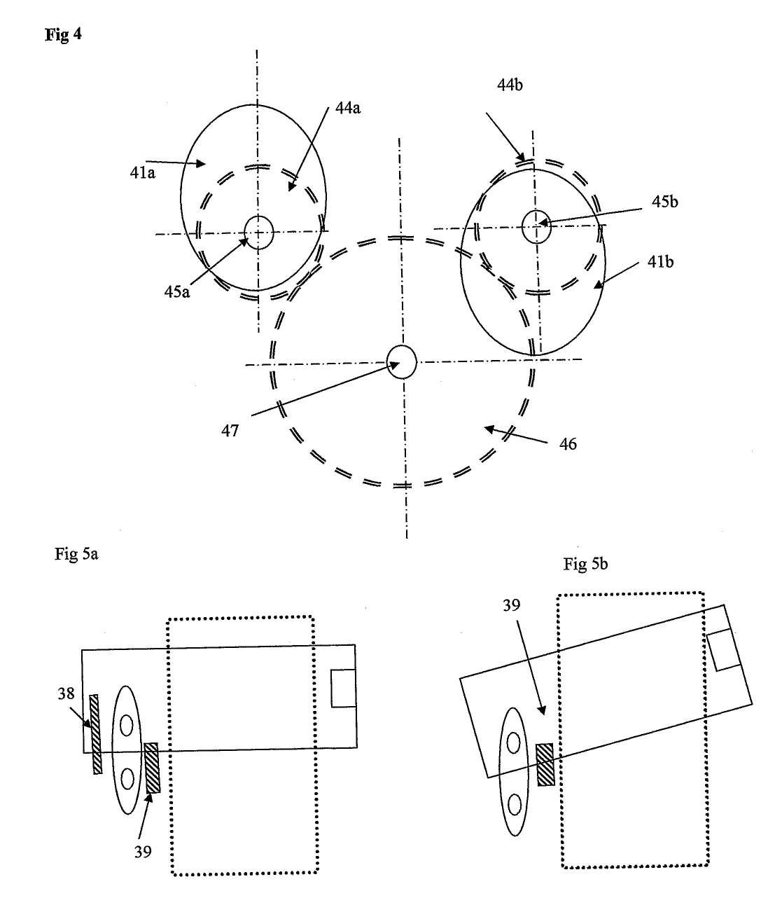

FIG. 4 shows a front view of the operating mechanism of the safety and drive mechanisms

FIGS. 5a and 5b show two side schematic views of the linkage of the safety and drive mechanism with the support guide

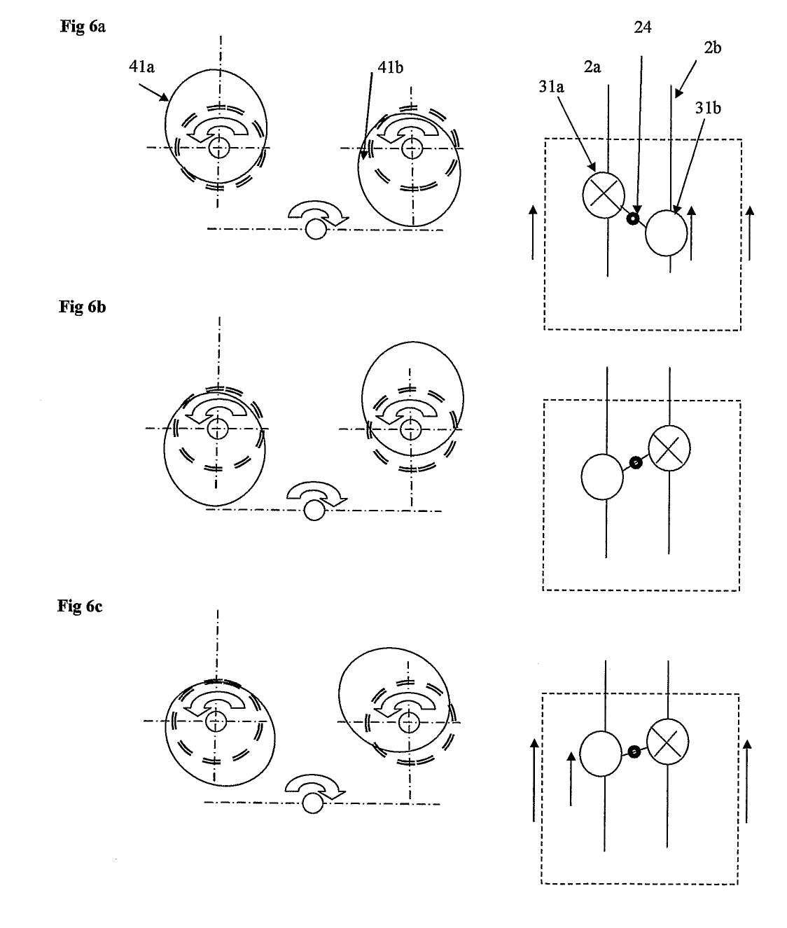

FIGS. 6a, 6b, 6c show three successive schematic views of the operating mechanism and the relative advance of the gondola on the support guide

FIG. 7 shows a cam in front view

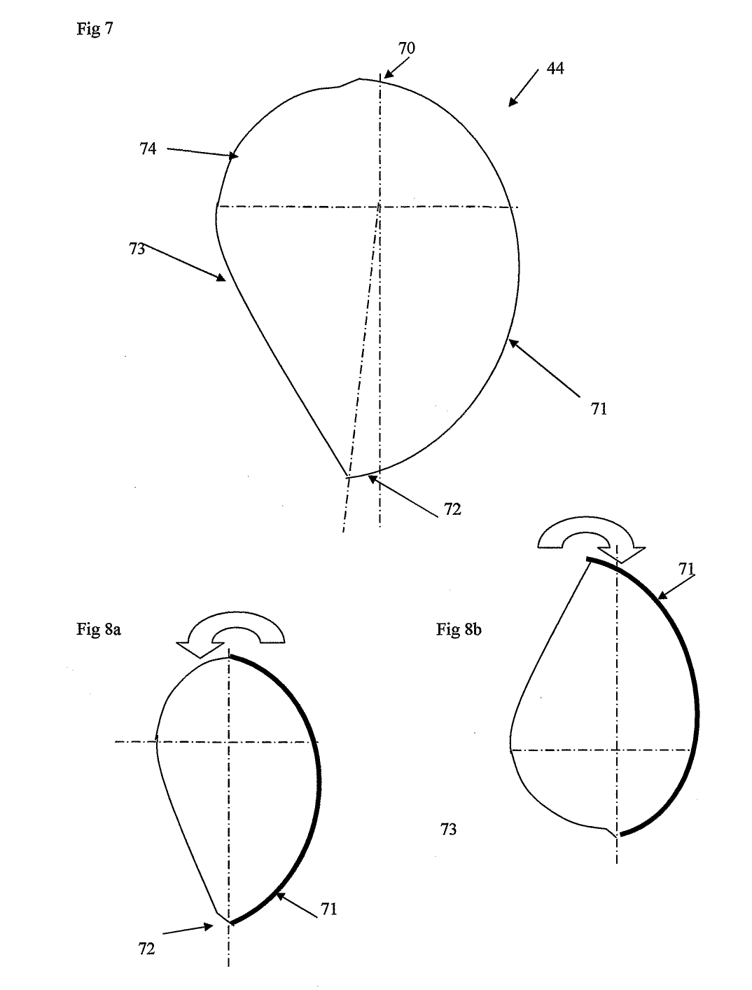

FIGS. 8a and 8b show the active cam portions according to the descent or ascent situation.

FIG. 1a shows a front view and FIG. 1b shows a plan view of a user positioned on a gondola (11) of the traditional type, moved by a safety and drive device (10), which slides over two rails (2) positioned along a wall (4). The two guide rails (2) are connected by a web (5) against which a facade linkage (15) is solidly connected. This facade linkage (15) is of a known type, anchorage, threaded joint, fixing device, hooping, and is applied to the facade (4) such as that of FIG. 1c which is a pylori. FIG. 1c shows the support guide (2, 5) constituted by two rails (2a, 2b) which are essentially rectangular and around which jaws (31a, 31b), which will be described below, are positioned so as to secure an advance of the gondola (11) along this support guide (2, 5). The support guide (2, 5) is preferably produced for a mix of conditions of low-cost manufacture and ease of use, from a profile made of aluminium or another metallic material by means of a die. FIG. 2 shows a general front view of the safety and drive mechanism on the support guide (2, 5). To make the drafting of the text more convenient, the numbers in the figure with a will designate the left-hand rail (2a) and the right-hand rail numbers will designate the right-hand rail (2b) throughout the remaining text. Since the elements acting on the left-hand rail (2a) are symmetrical with those acting on the right-hand rail (2b), they are designated generally without the numbering with a or b. A secure jaw (31, 32) described more particularly in FIG. 3 is positioned around each rail (2). The path of the secure jaws (31, 32) is rectilinear and guided by the rails (2). Each guided jaw (31, 32) has a catch (34) on its rear outer surface which slides in an oblong catch hole (28) positioned at each end of a rigid rocking lever (25), and the centre of rotation of which rocking lever is aligned and positioned in the middle of the two catch holes (28). The function of these oblong holes (28) is to convert the rectilinear movement of the secure jaws (31, 32) along the rails (2) into a rotary movement of the rocking lever (25). The frame of the gondola is connected solidly to the rotational centre (24) of the rocking lever. It is thus understood straight away that, with this rocking lever (25), the movement of the two secure jaws (31, 32) will be coordinated and diametrically opposed about the rotary mounting centre (24) of the rocking lever (25), and that the movement of the secure jaws (31, 32) imparts by translation of the rotary mounting centre (24) of the rocking lever (25) a translational movement to the frame of the gondola (10, 11) along the support guide (2, 5). FIG. 3 shows a side view of the safety and drive mechanism (10) along a rail (2) which comprises a secure jaw operating mechanism (41, 45, 44, 46, 47) and a secure jaw (31, 32). The secure jaw (31, 32) of a known type, patent PCT/FR2004/000552, comprises a guide block (32) sliding on the rail connected by an elastic moment (37, 38, 39) which positions the jaw in a locked position, FIG. 5b, or in a free position, FIG. 5a. This elastic moment (37, 38, 39) comprises a pair of springs, front (38) and rear (39), in tension and in extension, disposed on each side of a double-axis pivot positioned on the one hand on the guide block (32) and on the other hand on the guide jaw (31), FIG. 5a, or a single rear spring (39), FIG. 5b. The sought effect with one spring or with two springs is to create a locking moment, such that the jaw locks as soon as it is no longer pushed upwards. The two versions are identical in their outcome. The version with one spring is lighter, more economical and safer, and that with two springs allows the stiffness to be regulated more easily by acting on the stiffness of the more easily accessible rear spring. The guide block (31) comprises a catch (34) for the catch hole (28) of the rocking lever (25). The rear spring (38) is linked to the safety and drive operating mechanism (10) by a guide (36), at the end of which there is mounted a small wheel (35) which rolls on the periphery of a cam (41) set in motion by a shaft (45), on which there is also mounted a cam pinion (44) which is linked to a motorisation pinion (46), the rotation whereof is provided by the driving shaft (47) of the motorisation of the safety and drive device (10). FIG. 4 shows a front schematic view of the operating mechanism for the safety and drive mechanisms (41, 45, 44, 46, 47) and comprises a driving shaft (47) which feeds a pinion (46) on which there are mounted symmetrically two cam pinions (44a, 44b) each mounted on a shaft (45a, 45b) which causes the rotation of two identical cams (41a, 41b) mounted in a position inverted by 180°, in such a way that a half turn of a first cam positions this cam in the position of the second cam before this half turn. This assembly in an inverted position makes it possible to coordinate the two cams (41a, 41b) in a driven manner and thus to adapt the respective positions of the two jaw catches (34) positioned symmetrically about the rotary mounting centre of the rocking lever (24). FIGS. 6a, 6b, 6c show three successive schematic views of the operating mechanism and the relative advance of the gondola on the support guide with, in FIG. 6a, the left-hand jaw (31a) in a locked position and the right-hand jaw (31b) which is free and pushed upwards by the pinion cam (41b) which thus carries along the gondola (11) by means of the rotary mounting centre of the balancing lever (24). In FIG. 6b, the cams under the propulsion of the driving shaft (47) are turned through one half turn, and the gondola has advanced in height through the swiveling of the rocking lever about a fixed point on the left-hand rail (2a). In this situation, the right-hand jaw (31b) is locked and the left-hand jaw (2a) is released and is moved upwards by the left-hand cam (41a). In FIG. 6c, the angular advance of the cam is approximately 30° and the left-hand jaw has advanced upwards in its course by a ratio of approximately 40%, which maintains a vertical advance at a constant speed as explained in FIG. 7, which shows a cam (44) in front view with an essentially elliptical and asymmetric potato-like shape. It is understood that, depending on the direction of rotation, i.e. in the anticlockwise direction, FIG. 8a, the rotation of the cam (44) accompanies the ascent of the secure jaw (31, 32) and thus of the gondola (11) according to its ascent flank (71), whilst in the clockwise direction, FIG. 8b, the rotation of the cam (44) accompanies the descent of the secure jaw (31, 32) according to its descent flank (70, 71, 72) and thus of the gondola (11). The surface of the cam has a relay angular portion (72) in order to unlock the jaw for the descent. The relay angular portion (72) for disengagement is operated in the clockwise direction. It abuts against small wheel (35) and disengages by this effect from the cam stop (44). FIGS. 7 and 8b show a first version of the relay angular portion (72) for the disengagement, in which the advance of the cam advances beyond 180° and cooperates with a particular height of small wheel (35). FIG. 8a shows another shape of the leading edge of the relay angular portion (72) for the disengagement, in which the small wheel is positioned slightly lower, in this version the relay angular portion (72) projecting with respect to the inert portion (73), but not exceeding 180° as in the preceding version. This solution permits better coordination during ascent with a sharp ascent halt at 180°. In the version of FIG. 8b, the surface of the cam (44) has an ascent surface very slightly over 180° in the manner of relay angular portion (72), in such a way that, during ascent, contrary to what is explained in FIG. 6b, there is a very slight stagger between the moment when the left-hand jaw is released for the ascent and that of the right which is on the point of being locked. This relay angular portion (72) thus has the function of contributing towards maintaining a uniform linear ascent speed for the advance of the gondola (11) on the support guide (2, 5). These shapes of the leading edge for the disengagement and coordination of one locking device with the other result from a subtle mechanical equilibrium and are dependent on the coordination of a number of pieces and in particular that of the shape of the small wheel. This explains the different versions of the cam shape (44) for the relay coordination and disengagement portion. The essentially elliptical shape of the cam (44) contributes towards ensuring a continuous advance of the secure jaw (31, 32) for a continuous rotation of the cam driving shaft (47). The cam comprises an inert portion (73) which is never in contact with the jaw block (31, 32) and a non-active contact portion (74) with a view to resuming the drive contact at the start of the advancing cycle (70).

The present invention thus relates to a gondola advancing vertically along a support guide (2, 5) solidly connected (15) to the wall (4), characterised in that the support guide (2, 5) comprises at least two smooth rails (2a, 2b), the gondola (11) comprises along each of the two rails (2a, 2b) two secure jaws (31a, 32a) (31b, 32b) for mechanical locking, each secure jaw (31, 32) comprising a catch (28, 34) positioned at each of the ends of a rocking lever (25), the centre of rotation of the rocking lever (24) is aligned and positioned in the middle of the two catches (28, 34), the frame of the gondola is solidly connected to the centre of rotation (24) of the rocking lever, safety and drive means (10) move the two secure jaws (31, 32) in translation diametrically opposed about the rotary centre (24) of the rocking lever (25), said secure jaws imparting a translational movement to the frame of the gondola (10, 11).

The present invention thus relates to a gondola advancing vertically along a support guide (2, 5), characterised in that the safety and drive means (10) comprise a driving shaft (47) which impels two cam pinions (44a, 44b) which cause the rotation of two identical cams (41a, 41b) mounted in a position inverted by 180°, a small wheel (35) is mounted on the rear of each of the secure jaws and rolls on the cam periphery (41) and transmits to the jaw the vertical rectilinear movement of the cam contact point.

The present invention thus relates to a gondola advancing vertically along a support guide (2, 5), characterised in that, in one direction, the rotation of the cam (41) accompanies the ascent of the secure jaw (31, 32) and thus of the gondola (11) according to its ascent flank (71), whilst in the other direction the rotation of the cam (41) accompanies the descent of the secure jaw (31, 32).

The present invention thus relates to a gondola advancing vertically along a support guide (2, 5), characterised in that the surface of the cam (41) has an offset in the form of a relay angular portion (72) in order to unlock the jaw for the descent.

The present invention thus relates to a gondola (11) advancing vertically along a support guide (2, 5), characterised in that the shape of the cam (41) contributes towards ensuring a uniform advance of the secure jaw (31, 32) for a uniform rotation of the cam driving shaft (47).

The present invention thus relates to a gondola advancing vertically along a support guide (2, 5), characterised in that the cam (41) comprises an inert portion (73) which will never be in contact with the jaw block (31, 32) and a non-active contact portion (74) with a view to resuming the drive contact at the start of the advancing cycle (70).

The present invention thus relates to a gondola (11) advancing vertically along a support guide (2, 5), characterised in that the cam (41) has an active portion during ascent over 180° of its periphery, a same active portion over 180° during descent with in addition a projecting portion of a relay angular portion (72) for disengagement.

The present invention thus relates to a gondola (11) advancing vertically along a support guide (2, 5), characterised in that the guide jaw (31, 32) comprises a double-axis pivot positioned on the one hand on a guide block (32) and on the other hand on a guide jaw (31).

It can clearly be seen that numerous variants possibly capable of being combined can be provided here without ever departing from the scope of the invention such as it is defined below.

1. Gondola advancing vertically along a support guide (2, 5) solidly connected (15) to the wall (4), characterised in that the support guide (2, 5) comprises at least two smooth rails (2a, 2b), the gondola (11) comprises along each of the two rails (2a, 2b) two secure jaws (31a, 32a) (31b, 32b) for mechanical locking, safety and drive means (10) convert a rotating operating motorized driving shaft (47) movement into a coordinated rectilinear movement of the two secure jaws (31, 32), said secure jaws imparting a translational movement to the frame of the gondola (10, 11), the frame of the gondola is solidly connected to the safety and drive means (10).

2. The gondola according to claim 1, characterized in that the safety and drive means (10) convert constant rotating speed of the rotating operating motorized driving shaft (47) into a constant speed of the rectilinear movement of the secure jaws (31, 31) along the rails (2) and hence that of the gondola along the support guide (2, 5).

3. The gondola (11) according to claims 3 and 4, characterised in that each secure jaw (31, 32) comprise a catch (28, 34) positioned at each of the ends of a rocking lever (25), the centre of rotation of the rocking lever (24) is aligned and positioned in the middle of the two catches (28, 34), the frame of the gondola is solidly connected to the centre of rotation (24) of the rocking lever

4. The gondola (11) advancing vertically along a support guide (2, 5) according to claim 3, characterised in that the safety and drive means (10) comprise a driving shaft (47) which impels two cam pinions (44a, 44b) which cause the rotation of two identical cams (41a, 41b) mounted in a position inverted by 180°, a small wheel (35) is mounted on the rear of each of the secure jaws and rolls on the cam periphery (41) and transmits to the jaw the vertical rectilinear movement of the cam contact point.

5. The gondola (11) advancing vertically along a support guide (2, 5) according to claims 3 and 4, characterised in that, in one direction, the rotation of the cam (41) accompanies the ascent of the secure jaw (31, 32) and thus of the gondola (11) according to its ascent flank (71), whilst in the other direction the rotation of the cam (41) accompanies the descent of the secure jaw (31, 32).

6. The gondola (11) advancing vertically along a support guide (2, 5) according to claims 3, 4 and 5, characterised in that the surface of the cam (41) has an offset of a relay angular portion (72) in order to unlock the jaw for the descent.

7. The gondola (11) advancing vertically along a support guide (2, 5) according to claims 3 and 4, characterised in that the shape of the cam (41) contributes towards ensuring a uniform advance of the secure jaw (31, 32) for a uniform rotation of the cam driving shaft (47).

8. The gondola (11) advancing vertically along a support guide (2, 5) according to claims 3, 4 and 5, characterised in that the cam (41) comprises an inert portion (73) which will never be in contact with the jaw block (31, 32) and a non-active contact portion (74) with a view to resuming the drive contact at the start of the advancing cycle (70).

9. The gondola (11) advancing vertically along a support guide (2, 5) according to claims 3, 4 and 5, characterised in that the cam (41) has an active portion during ascent over 180° of its periphery, a same active portion over 180° during descent with in addition a projecting portion of a relay angular portion (72) for disengagement.

10. The gondola (11) advancing vertically along a support guide (2, 5) according to claim 3, characterised in that the guide jaw (31, 32) comprises a double-axis pivot positioned on the one hand on a guide block (32) and on the other hand on a guide jaw (31).
